(19) United States
(12) Patent Application Publication
(10) Pub. No.: US 2016/0299531 A1
(43) Pub. Date: Oct. 13, 2016

(54) Cylindrical Computing Device with Flexible Display

(71) Applicant: Roel Vertegaal, Perth Road (CA)

(72) Inventor: Roel Vertegaal, Perth Road (CA)

(21) Appl. No.: 15/073,091

(22) Filed: Mar. 17, 2016

Related U.S. Application Data
(60) Provisional application No. 62/134,268, filed on Mar. 17, 2015.

(51) Int. Cl. G06F 1/16; G06F 3/0346; G06F 3/0362; G06F 3/044; G06F 3/0488

(52) U.S. Cl. CPC G06F 1/1652; G06F 3/044; G06F 3/0488; G06F 3/0362; G06F 3/0346; G06F 2203/04102

(57) ABSTRACT

A mobile computing device with a substantially cylindrical form factor and a flexible display screen. The flexible display screen is adapted to display content when it is substantially completely wrapped around the cylindrical body, partially wrapped around the cylindrical body, or substantially not wrapped around the cylindrical body. In one embodiment the flexible display comprises a touch-sensitive user interface. The mobile computing device may be a smartphone, a tablet pc, a personal digital assistant, a music player, a gaming device, a remote control, or a combination thereof.

### RELATED APPLICATION

This application claims the benefit of the filing date of U.S. Patent Application No. 62/134,268, filed on Mar. 17, 2015, the contents of which are incorporated herein by reference in their entirety.

### FIELD

This invention relates to mobile computing devices with flexible display screens. In particular, the invention relates to a mobile computing device with a cylindrical form factor, and a flexible display that can be rolled around the cylindrical device.

### INTRODUCTION

Computing devices with non-flat display screens allow physical affordances that traditional flat displays are incapable of providing. For example, a non-flat display screen can supplement virtual objects with physical affordances provided by the shape of the display screen. Display form factors other than flat have previously been proposed. For instance, Poupyrev et al. (Poupyrev, I, et al., 2006, D20: Interaction with multifaceted display devices, In CHI '06 Extended Abstracts on Human Factors in Computing Systems (CHI EA '06), pp. 1241-1246) presented D20, an icosahedral display device rendered as a 3D object and controlled by an external non-display device. Pillias et al. (Pillias, C., et al., 2013, Reading with a digital roll, In CHI '13 Extended Abstracts on Human Factors in Computing Systems (CHI EA '13), pp. 1377-1382) used a similar approach when exploring a hand-held cylindrical form factor called Digital Roll. Akaoka et al. (Akaoka, E., et al., 2010, Display Objects: Prototyping functional physical interfaces on 3d styrofoam, paper or cardboard models, In Proceedings of the fourth international conference on Tangible, embedded, and embodied interaction (TEI '10), pp. 49-56) used projection mapping to render interfaces on the surface of objects, including the cylindrical DynaCan. Multi-faceted display prototypes have also been constructed by stitching flat displays together. Examples include Display Blocks (Pla, P., et al., 2013, Display blocks: A set of cubic displays for tangible, multi-perspective data exploration, In Proceedings of the 7th International Conference on Tangible, Embedded and Embodied Interaction (TEI '13), pp. 307-314) and pCubee (Stavness, I., et al., 2010, pCubee: A perspective-corrected handheld cubic display, In Proceedings of the SIGCHI Conference on Human Factors in Computing Systems (CHI '10), pp. 1381-1390), the latter adding a headtracker to simulate motion parallax. However, all of these approaches use display screens with multiple displays fixed in multifaceted shapes, or a display screen fixed in a curved shape, and do not permit user interaction by manipulating the shape of the display screen.

Devices such as game controllers may be used to support the expression of hand gestures in gaming environments. This has been explored in projects such as XWand (Wilson, A., et al., 2003, XWand: UI for intelligent spaces, In Proceedings of the SIGCHI Conference on Human Factors in Computing Systems (CHI '03), pp. 545-552), an electronic wand that allows a user to point at other devices for control. Similar form factors have been used commercially in motion-sensing game controllers, including the Nintendo Wii Remote (Nintendo of America Inc., Redmond, USA), and the Sony PlayStation Move (Sony Computer Entertainment, Inc., Tokyo, Japan). Typical game controllers, however, do not feature embedded displays. One notable exception is the Nintendo Wii U GamePad, although its embedded display is rigid and flat. While smartphones may be adapted as an alternative for gestural input using built-in inertial sensors, they generally lack a form factor and other features suitable for such use.

### SUMMARY

Described herein is a mobile computing device, comprising: a rigid substantially cylindrical body that houses electronic circuitry, and a flexible display that is attached to the cylindrical body and electrically connected to the electronic circuitry; wherein the flexible display is adapted to display content when it is substantially completely wrapped around the cylindrical body, partially wrapped around the cylindrical body, or substantially not wrapped around the cylindrical body.

In one embodiment the flexible display comprises a FOLED display. In one embodiment a flexible touch layer is disposed on the flexible display. The flexible touch layer may comprise a capacitive touch layer. The flexible display may display content that comprises a touch-sensitive user interface.

In one embodiment the mobile computing device comprises at least one wheel; wherein a said at least one wheel is disposed at at least one end of the cylindrical body; wherein the at least one wheel has an axis of rotation substantially aligned with a longitudinal axis of the cylindrical body; wherein the at least one wheel is adapted to provide input to the device, and/or wherein the at least one wheel is adapted to propel the device. In one embodiment each end of the cylindrical body comprises a said wheel.

In one embodiment the flexible display maintains an orientation of displayed content, relative to a reference, during movement of the mobile computing device.

In one embodiment the flexible display comprises at least one bend sensor that detects continuous or discrete bends in the flexible display as input to the mobile computing device.

Also described herein is a method for displaying content a mobile computing device, comprising: housing electronic circuitry of the mobile computing device in a rigid substantially cylindrical body; and attaching a flexible display to the cylindrical body and electrically connecting the flexible display to the electronic circuitry; wherein the flexible display is adapted to display content when it is substantially completely wrapped around the cylindrical body, partially wrapped around the cylindrical body, or substantially not wrapped around the cylindrical body.

The method may comprise disposing a flexible touch layer on the flexible display, wherein the flexible display displays content that comprises a touch-sensitive user interface.

One embodiment comprises disposing at least one wheel on the cylindrical body; wherein a said at least one wheel is disposed at at least one end of the cylindrical body; wherein the at least one wheel has an axis of rotation substantially aligned with a longitudinal axis of the cylindrical body; wherein the at least one wheel is adapted to provide input to the device, and/or wherein the at least one wheel is adapted to propel the device.

The method may comprise maintaining an orientation of displayed content on the flexible display, relative to a reference, during movement of the mobile computing device.

The method may comprise disposing at least one bend sensor that detects continuous or discrete bends in the flexible display as input to the mobile computing device.

The embodiments may include using the mobile computing device as a smartphone, a tablet pc, a personal digital assistant, a music player, a gaming device, a remote control, or a combination thereof.

On embodiment comprises using the mobile computing device as a smartphone.

On embodiment comprises using the mobile computing device as a pointing device or as a gestural input device.

Another embodiment comprises using the mobile computing device as a gaming controller, wherein the mobile computing device provides a secondary gaming display.

### BRIEF DESCRIPTION OF THE DRAWINGS

For a greater understanding of the invention, and to show more clearly how it may be carried into effect, embodiments will be described, by way of example, with reference to the accompanying drawings, wherein:

FIGS. 1A and 1B are diagrams showing a cylindrical computing device with a flexible display, wherein the flexible display is rolled around the computing device (FIG. 1A) and partially unrolled (FIG. 1B), according to one embodiment.

FIG. 2 is a diagram showing a cylindrical computing device with a flexible display fully unrolled from the computing device, configured as tablet, according to one embodiment.

FIG. 3 is a diagram showing a cylindrical computing device with a flexible display fully rolled around the computing device, configured as a smartphone, according to one embodiment.

FIG. 4 is a diagram showing a cylindrical computing device with a flexible display rolled around the computing device, wherein rolling the device on a surface provides input via at least one scroll wheel at the end of the device (left panel), and wherein the device produces its own rolling action using servomotor controlled scroll wheels located at the ends of the device (FIG. 4, right panel), according to embodiments described herein.

FIG. 5 is a diagram showing examples of movement patterns of the embodiment of FIG. 4, right panel.

FIG. 6 is a diagram showing a cylindrical computing device used as a remote control with an application for controlling an appliance, according to one embodiment.

### DETAILED DESCRIPTION OF EMBODIMENTS

As used herein, the terms “computing device” and “mobile computing device” refer to, but are not limited to, a smartphone, a tablet personal computer, a personal digital assistant, a music player, a gaming device, a remote control, or a combination thereof.

Described herein is a substantially cylindrical handheld computing device having at least one flexible display. As used herein, the terms “cylindrical” and “substantially cylindrical” are intended to refer to an elongated shape having a cross-section that is circular, or partially circular, such as oval or ovoid, or a cross-section that is irregularly shaped. Preferably, the cross-section has no corners so that a flexible display may be wrapped around it without damage, and also so that it is comfortable to grip during hand-held use. Thus, although the term “cylindrical” is conveniently used throughout this description, it will be appreciated that embodiments are not limited thereto.

The at least one display may be any type of flexible organic light emitting diode (FOLED) display. The term FOLED is used herein to refer to all such flexible displays, (such as, but not limited to polymer (plastic) organic LED (POLED) displays, and active matrix organic LED (AMOLED) displays). The FOLED may have a resolution of, for example, 1920×1080 pixels (403 dpi), although displays with lower resolution or higher resolution such as 4K or 8K may also be used. The display includes a touch screen layer disposed thereon. The touch screen may be flexible multi-touch layer. Generally the touch screen layer may have the same or a lower resolution than the flexible display resolution.

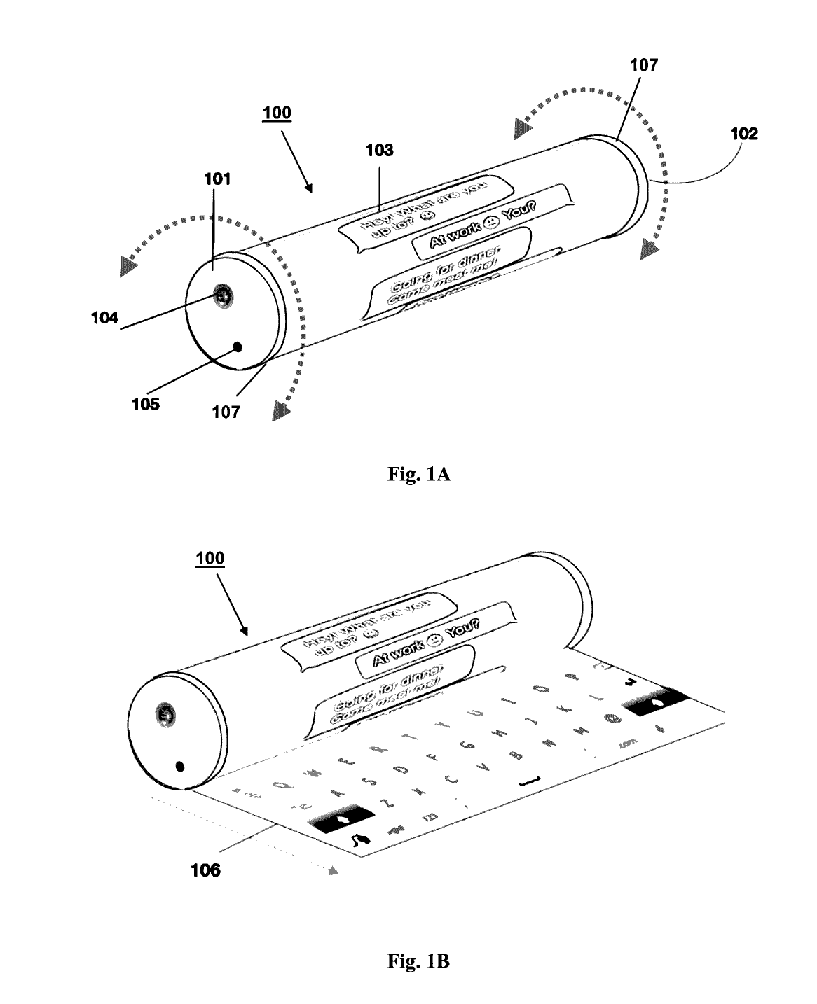

FIGS. 1A and 1B show embodiments of the device. In the embodiment of FIG. 1A, the FOLED display 103 is wrapped around all or a portion on the cylindrical body of the device, such that substantially the entire curved surface of the device (excluding the ends 101) is covered with pixels. The FOLED display may be affixed to the curved surface of the device. In the embodiment of FIG. 1B, the FOLED display is not affixed to the curved surface of the device, such that it can be unrolled from the cylinder to assume another form factor, for example, the screen of a tablet PC. In this embodiment the device may be used with the display in a semi-unrolled state, as shown in FIG. 1B, where an input screen 106 (e.g., a keyboard touchscreen) may be presented on the unrolled portion of the display 103, used for text/data entry, while the rolled-up portion of the display remains available to present text, data, etc.

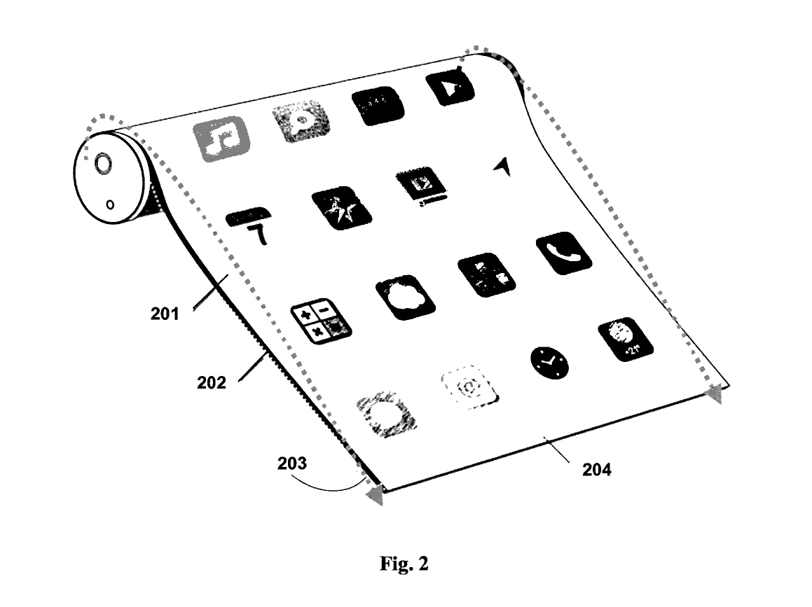

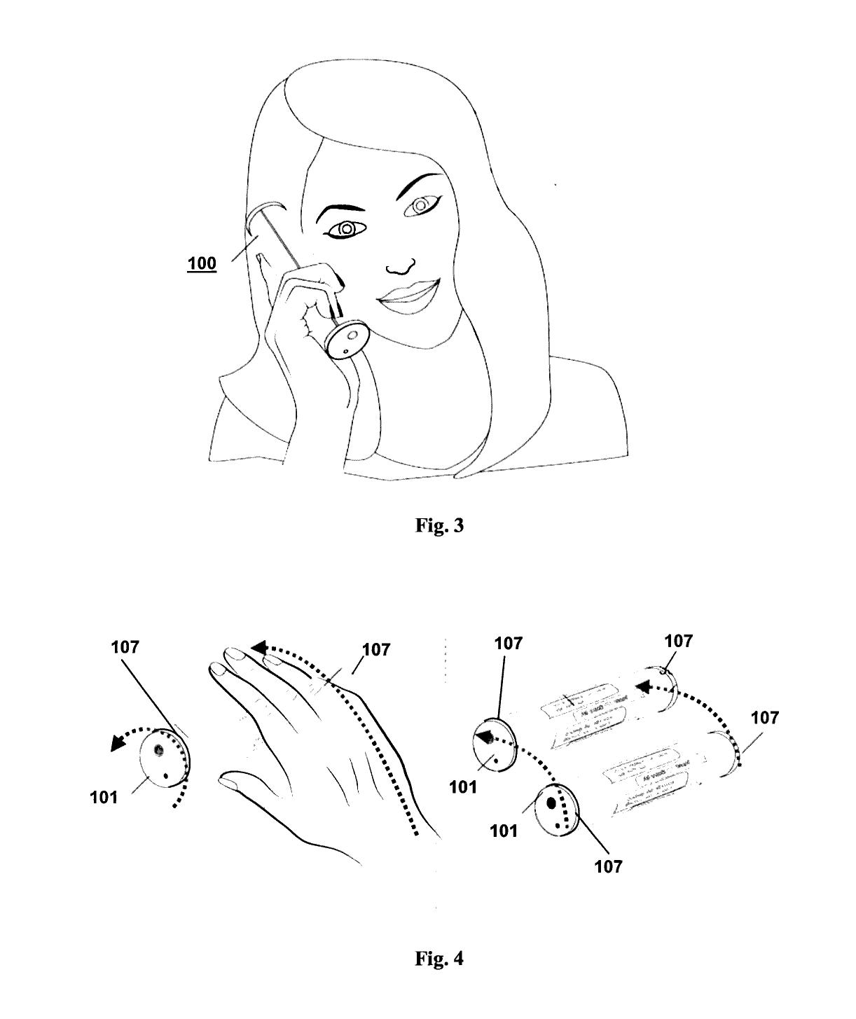

When more display screen real estate is required, the display may be rolled out completely, analogous to a scroll, into a multi-touch tablet-sized device, as shown in FIG. 2. In one embodiment, a flexible metal ribbon support 202 similar to a metal tape measure is provided to support the rolled out screen 201. A magnet strip 204 may be used to secure the display to the cylindrical body when rolled up. In one embodiment, one or more bend sensor 203 associated with the display surface allows the device to detect bend input. In another embodiment, shown in FIG. 3, the display is rolled back around the cylindrical body and the device 100 functions as a smartphone stick.

The cylindrical body houses hardware including processing, communications, inertial sensor (e.g., inertial measurement unit (IMU)), and power management circuitry, and a battery. In one embodiment, the device includes an Android® smartphone board featuring cellphone, WiFi, Bluetooth, and optional USB network connectivity. The ends 101 accommodate one or more hardware features such as, for example, connections for power, USB, and audio; as well as a camera lens 104, flash and/or lighting device, speaker 102, and microphone 105.

In some embodiments, one or both of the ends of the cylindrical body 101 includes a wheel 107 at its perimeter that rotates about the longitudinal axis of the device. At least one wheel 107 may be configured as a scroll wheel. For example, when a user turns the wheel (indicated by dashed lines and arrows in FIG. 1A), it provides input to the device using rotary encoders. The at least one wheel may be rotated by the user while being held, or by pushing the device on a surface as shown in FIG. 4, left panel, which may also provide input as gestural communication. In another embodiment at least one of the wheels 107 is driven by a motor or servo housed in the cylindrical body that can propel the device on a surface. In this embodiment, shown in FIG. 4, right panel, the display is rolled around the cylindrical body, and with the device placed on a surface, at least one wheel can provide movement patterns for the device as, e.g., notifications. Movements may be recorded and played back. In one embodiment, two or more devices can be configured so that when a user moves a device (i.e., the “local” device) in a desired pattern or trajectory (FIG. 4, left panel), the device(s) of one or more other users (i.e., the “remote” devices) mimic the movement pattern or trajectory of the local device (FIG. 4, right panel). In one embodiment, while the device is in motion, the IMU data may be used to move graphics on the display surface such that they are always in a certain orientation (i.e., upright) position. That is, while the device moves around a surface, the displayed graphics appear not to move as the motion is compensated for in a graphics processing subsystem.

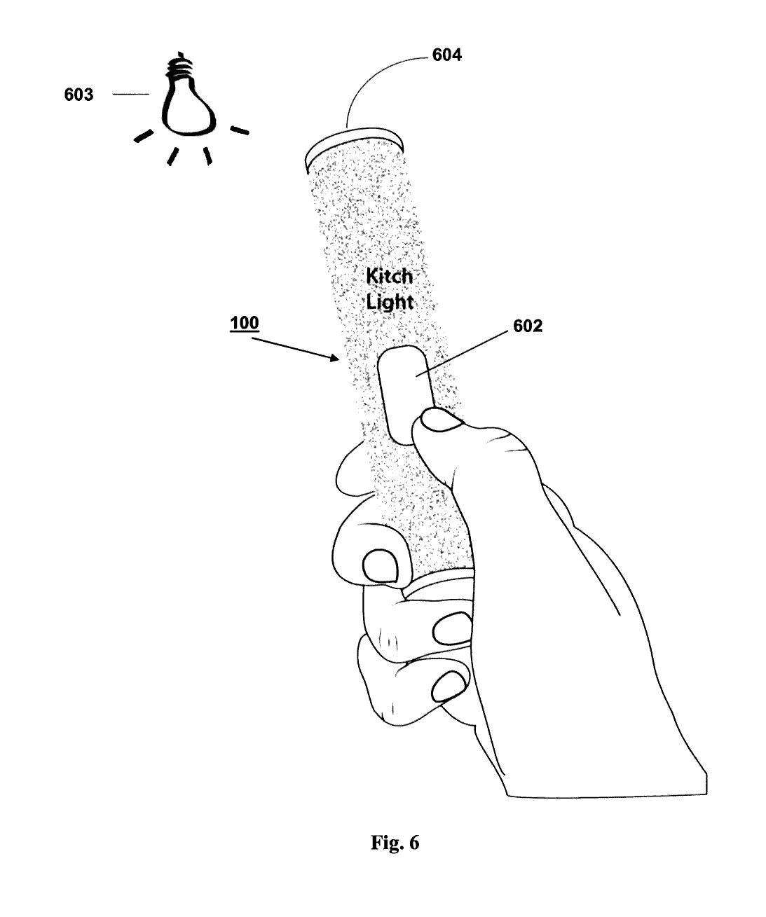

In another embodiment, gesture recognition software together with IMU data allows the device to receive input from gestural movements. The user may move the device in selected patterns which are recognized by the device as specific commands. The device may be trained to recognize custom gestural movements preferred by the user. The device may also be used as a pointing device (e.g., a remote control as shown in FIG. 6), and/or as a peripheral to a gaming system, in which the device is used as a primary or secondary input and output device.

Interaction Techniques As will be apparent from the above description, multiple modes of interacting with the device are available to the user. The flexible touch input screen provides for x,y input similar to most smartphones and other devices such as tablets with touch screens. Touch input may be used for selecting graphics, moving objects around the screen, scrolling, and the like. The one or more wheels can also be used as for input, such as for scrolling, by rotating the wheels by hand or when the device is resting on a surface. Rotating a wheel may, for example, enable moving graphics in the direction of the rotational action of the wheel. Wheel input may be performed bimanually, and can have separate effects for each hand. For example, the left hand can be used to open a menu, while the right hand can be used to move through menu items. One or more bend sensor(s) at the extremity of the display(s) may be used to detect bends of the entire screen(s), a dog ear gesture (top right bend), or a bottom dog ear gesture (bottom right deformation). Bend gestures may be used in both directions, and may be applied as a forward/back command to the interface. When bend gestures are interpreted in a discrete fashion, they can, for example, be used to navigate through pages of text one at a time. When bend gestures are interpreted continuous, the rate of changes in the page navigation can vary with the extend of the bend.

IMU data allows the device to recognize specific acceleration patterns that are detected as gestural input. In one embodiment, an algorithm was implemented that tracks peak accelerometer values within a time frame in order to recognize input gestures, such as swirls, slashes, pointing, and rotational actions. Examples of gestural input detection are discussed in the gaming example below.

### Implementation

An exemplary implementation will now be described. However, it will be appreciated that other implements and hardware/software selections may be used.

The cylindrical body had a radius of about 28 mm and a length of about 165 mm. All electronic circuitry and a rechargeable battery were housed in the cylindrical body. The circuitry included an Android circuit board running Android 5.1, an Adreno 430 GPU supporting OpenGL 3.1, a 1.5 GHz Qualcomm Snapdragon 810 processor, and 2 GB of memory. The rechargeable battery was charged through a USB connector at one of the ends of the cylindrical body.

The FOLED display had a total display surface of about 160 mm×135 mm and a resolution of 1440×1280 pixels (LG Display Co., Ltd.). A flexible capacitive touch layer (LG Display Co., Ltd.) that senses x,y touch with a resolution of 1440×1280 pixels was disposed on top of the FOLED display (LG Display Co, Ltd.).

A lengthwise slit in the cylindrical body allowed a connection edge of the FOLED display and the touch screen layer to pass into the cylindrical body, where they were connected to the electronic circuitry and clamped in place. The touch screen layer was disposed on top of the FOLED display, but preferably not glued to it so as to allow for movement between the display and touch screen layers when the rolling up and unrolling the display. This makes the display surface more flexible, reduces reliance on glue layers, and reduces strain by allowing the touch surface to obtain a larger radius than the FOLED surface when rolled around the cylinder.

The invention will be further described by way of the following non-limiting examples.

### Examples

Various applications for the device were developed and implemented as described below.

Gaming A game application was developed in Unity running on a server. The server communicated with the device over a local Wi-Fi network. The server received and processed incoming gestural data from the device and sent graphics to be displayed on the device. In this example, the device was used as a game controller and secondary display, and was typically used in a rolled up cylindrical state. A large external screen was used as the primary game display. The server controlled the primary display as well, running the game and coordinating all components. Compared to a flat handheld display, the cylindrical form factor of the device provided several affordances that enhanced game play. Flat displays have a discrete display area, limited to one side of the device. Typically, users grasp it with the fingers of one hand and interact with the fingers of the other hand via touch gestures. By contrast, the cylindrical display offers a continuous display area substantially 360 degrees around the device. This allowed users to grasp the device with one hand, making it ideal for wrist-based gestures.

To highlight some of the device's capabilities, the game was a first-person fantasy adventure game that required the player to use several tools—a wand, a sword, a magic potion—to interact with characters in order to overcome obstacles or enemies. The final goal was to collect characters and transport them from the device display to the primary display.

During the game, tools and characters were rendered on the device, with the player having to discover the new gesture to put the tool or character into action on the primary display. Experience suggests that the visual representation of the game objects on the device, supplemented with the device's unique physical affordances, make it easier for players to discover the new gestures. The device supported the following gestures:

Swirl: A character floating inside an animated tornado was displayed on the device. With a swirling gesture, the player accelerated the tornado and propelled the character over obstacles to reach a goal.

Slash: When a sword was displayed on the device, a slashing gesture allowed the player to destroy a spider web that blocked the way. When displaying a wand, a swirl followed by a slash was used to cast magic spells.

Rotation: A rotation gesture can be used when a key is displayed on the device, allowing the player to unlock a dungeon door.

Tilt: When the device displayed a potion-like liquid, a tilt gesture allowed the player to pour it into a cauldron to prepare a magic concoction.

Text Messaging In this example, a messaging application was developed for displaying messages from a text message user (see FIGS. 1A and 1B). The device was held horizontally with its screen(s) wrapped around the cylindrical body. The user scrolled through messages by moving a finger on the touchscreen, or by rotating (one of) the wheel(s) 107. The user provided text input through voice recognition, and/or by partially unrolling the display which revealed a keyboard on the display. In one embodiment the keyboard was on the touch surface and appeared near the cylindrical body of the device. In another embodiment the keyboard was implemented by a separate hardware touch surface on the non-display side of the screen, allowing for key input using keys printed in hardware on the back of the display.

### Use as a Phablet

When the display of the device is unrolled, the display becomes visible creating a phablet form factor (FIG. 2). This can be used as a regular tablet PC, with touch input providing x,y coordinates to the user interface. A user can start an application by touch, and can navigate between panes by providing rotary input via a scroll wheel 107. Upon rotating the scroll wheel to the left, the pane to the right of the currently displayed pane becomes visible. Upon rotating the scroll wheel to the right, the pane to the left of the currently displayed pane becomes visible. For example, a user can start a web browser, holding the display in portrait orientation. In another example, a user can open an e-book reader that shows a full page view of a book. A user can navigate through the book by bending the extremity of the display, causing the e-book to page forward when bent away, and back when bent towards the user. The IMU can detect when the phablet is held in landscape mode. In this mode, scroll wheel input serves to scroll the currently displayed content up when the wheel is rotated clockwise, and down when the wheel is rotated counterclockwise.

### Remote Robotic Actions

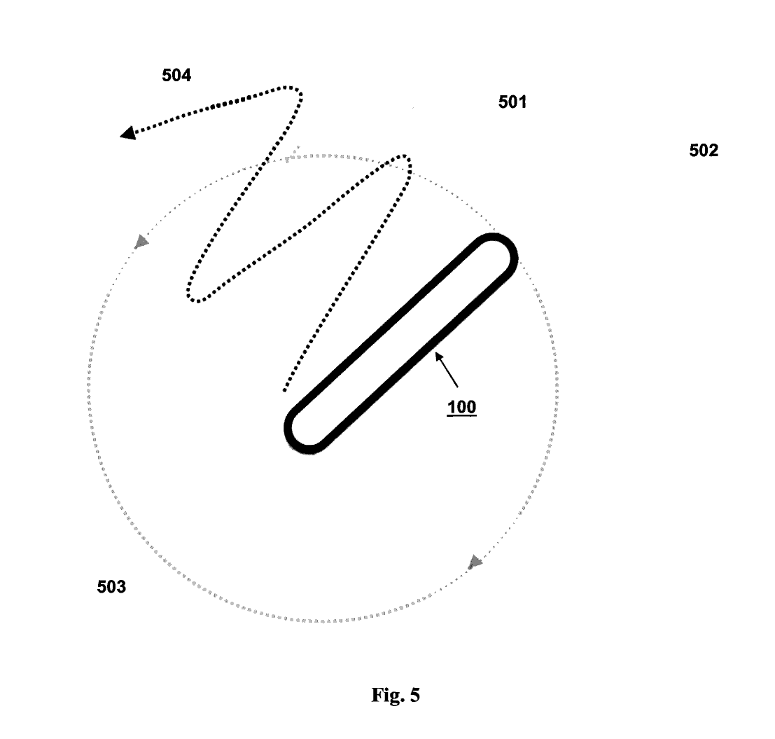

In this application the device is used as a messaging device with motion notification. The two motorized scroll wheels 107 give the device many movement options. For example, as shown in FIG. 5, it can move in a circle 501, con-circular 502 around the right wheel or con-circular 503 around the left wheel, or in any complex combination 504, giving a user the freedom to personalize notifications with different movement patterns. Movement patterns can be recorded by moving the device around the surface in a particular pattern. Such movement patterns can be associated with events such as notifications triggered in the device computer system. Upon receiving such event (for example, a social network update), the device checks its IMU data to ensure it is in a horizontal position. It also checks that its display is rolled up. It then starts moving according to the pre-recorded pattern of movement by engaging its motors. Since each wheel contains a rotary encoder that can act as an input device, the device can send gestures between users on a network. This is done by placing the devices on a surface during a text messaging session, and rolling a hand across the surface of one device. The device on the other side of the conversation checks that it is in a state capable of moving, and then starts mimicking the movement, allowing friends to exchange gestures.

### Remote Control

In this application (see FIG. 6) an infrared camera 604 disposed on the tip of the device 100 detects an object 603 in the environment through computer vision. The device thus serves as a universal remote control that connects to any appliance via a home automation protocol. A user points the device at a smart home appliance, e.g., a light 603. Although the light appears off, it is sending out an infrared beacon (e.g., a pulse train of infrared light) that is detected by the infrared camera 604. The camera decodes the pulses of the infrared beacon and starts a remote control application that places a switch 602 on the device display (e.g., under the user's thumb). The user then flips the switch and the smart appliance responds by turning on. In an alternative embodiment, the camera processes visible light to detect smart home appliances through image recognition techniques known in the art.

All cited publications are incorporated herein by reference.

### EQUIVALENTS

While the invention has been described with respect to illustrative embodiments thereof, it will be understood that various changes may be made to the embodiments without departing from the scope of the invention. Accordingly, the described embodiments are to be considered merely exemplary and the invention is not to be limited thereby.

1. A mobile computing device, comprising:
a rigid substantially cylindrical body that houses electronic circuitry;
a flexible display that is attached to the cylindrical body and electrically connected to the electronic circuitry;
wherein the flexible display is adapted to display content when it is substantially completely wrapped around the cylindrical body, partially wrapped around the cylindrical body, or substantially not wrapped around the cylindrical body.

2. The mobile computing device of claim 1, wherein the flexible display comprises a FOLED display.

3. The mobile computing device of claim 1, comprising a flexible touch layer disposed on the flexible display.

4. The mobile computing device of claim 3, wherein the flexible touch layer comprises a capacitive touch layer.

5. The mobile computing device of claim 3, wherein the flexible display displays content that comprises a touch-sensitive user interface.

6. The mobile computing device of claim 1, comprising at least one wheel;
wherein a said at least one wheel is disposed at at least one end of the cylindrical body,
wherein the at least one wheel has an axis of rotation substantially aligned with a longitudinal axis of the cylindrical body;
wherein the at least one wheel is adapted to provide input to the device, and/or
wherein the at least one wheel is adapted to propel the device.

7. The mobile computing device of claim 6, wherein each end of the cylindrical body comprises a said wheel.

8. The mobile computing device of claim 1, wherein the flexible display maintains an orientation of displayed content, relative to a reference, during movement of the mobile computing device.

9. The mobile computing device of claim 1, used as a pointing device or as a gestural input device.

10. The mobile computing device of claim 9, used as a gaming controller, wherein the mobile computing device provides a secondary gaming display.

11. The mobile computing device of claim 1, comprising at least one bend sensor that detects continuous or discrete bends in the flexible display as input to the mobile computing device.

12. The mobile computing device of claim 1, comprising a smartphone, a tablet pc, a personal digital assistant, a music player, a gaming device, a remote control, or a combination thereof.

13. A method for displaying content on a mobile computing device, comprising:
housing electronic circuitry of the mobile computing device in a rigid substantially cylindrical body;
attaching a flexible display to the cylindrical body and electrically connecting the flexible display to the electronic circuitry;
wherein the flexible display is adapted to display content when it is substantially completely wrapped around the cylindrical body, partially wrapped around the cylindrical body, or substantially not wrapped around the cylindrical body.

14. The method of claim 13, comprising disposing a flexible touch layer on the flexible display;
wherein the flexible display displays content that comprises a touch-sensitive user interface.

15. The method of claim 13, comprising disposing at least one wheel on the cylindrical body;
wherein a said at least one wheel is disposed at at least one end of the cylindrical body;
wherein the at least one wheel has an axis of rotation substantially aligned with a longitudinal axis of the cylindrical body;
wherein the at least one wheel is adapted to provide input to the device, and/or
wherein the at least one wheel is adapted to propel the device.

16. The method of claim 13, comprising maintaining an orientation of displayed content on the flexible display, relative to a reference, during movement of the mobile computing device.

17. The method of claim 13, comprising disposing at least one bend sensor that detects continuous or discrete bends in the flexible display as input to the mobile computing device.

18. The method of claim 13, comprising using the mobile computing device as a smartphone, a tablet pc, a personal digital assistant, a music player, a gaming device, a remote control, or a combination thereof.

19. The method of claim 13, comprising using the mobile computing device as a pointing device or as a gestural input device.

20. The method of claim 13, comprising using the mobile computing device as a gaming controller, wherein the mobile computing device provides a secondary gaming display.
